(19) United States
(12) Patent Application Publication
(10) Pub. No.: US 2015/0232008 A1
(43) Pub. Date: Aug. 20, 2015

(54) MOTOR VEHICLE BUCKET SEAT

(71) Applicant: Johnson Controls Metals and Mechanisms GmbH & Co., Solingen (DE)

(72) Inventor: Bernd Zimmerbeutel, Remscheid (DE)

(21) Appl. No.: 14/424,770

(22) PCT Filed: Sep. 12, 2013
(86) PCT No.: PCT/EP2013/068865

§ 371 Date: Feb. 27, 2015

(30) Foreign Application Priority Data
Sep. 12, 2012 (DE) 10 2012 108 506.4

(51) Int. Cl. B60N 2/68; B60N 2/72

(52) U.S. Cl. CPC B60N 2/68; B60N 2/72

(57) ABSTRACT

A motor vehicle bucket seat (1) is provided that can be produced economically and simply, has a low total weight, and is especially dimensionally stable. The motor vehicle bucket seat (1) has a metal seat bucket frame (2) having a backrest area (4) rigidly connected to a seat surface area (3). The seat bucket frame is formed by at least two seat bucket frame lateral parts (7, 8) arranged so as to overlap in at least one connection area and a seat cushion bucket (10) arranged therebetween in the seat surface area. The seat bucket frame lateral parts (7, 8) are each produced from at least two components (5, 6), which are fastened to each other so as to overlap in the transition area between the seat surface area (3) and the backrest area (4).

### CROSS REFERENCE TO RELATED APPLICATIONS

This application is a United States National Phase Application of International Application PCT/EP2013/068865 filed Sep. 12, 2013 and claims the benefit of priority under 35 U.S.C. §119 of German Patent Application DE 10 2012 108 506.4 filed Sep. 12, 2012, the entire contents of which are incorporated herein by reference.

### FIELD OF THE INVENTION

The present invention relates to a motor vehicle bucket seat.

### BACKGROUND OF THE INVENTION

Motor vehicle bucket seats of the type mentioned at the beginning are known in diverse configurations from the prior art and are used in particular for installing in sports cars. Special requirements are imposed in this case on the motor vehicle bucket seat. Firstly, high dimensional stability in relation to forces acting on the motor vehicle bucket seat is of high importance, but, secondly, in particular in the case of sports cars, as low an overall weight of the motor vehicle bucket seat as possible is also desired. A low overall weight and high dimensional stability are contradictory properties here since an increase in the dimensional stability is generally associated with an increased overall weight, and a reduction in the weight customarily also results in reduced dimensional stability.

The majority of motor vehicle bucket seats in the prior art are therefore formed from plastics and/or composite materials, wherein these motor vehicle bucket seats have a complex shape and are specially reinforced, in particular fiber-reinforced, in a plurality of regions in order to be able to meet the requirements imposed on a motor vehicle bucket seat in respect of dimensional stability. However, this complicated construction results in a disadvantageously high outlay on time and costs during production.

Another solution for the prior art for reducing the overall weight without significantly reducing the dimensional stability is to form a seat bucket frame from a dimensionally stable, but heavy material, and further components from lightweight construction materials. In this case, use is made in particular of steel tubes for the basic structure of the seat bucket frame, while composite materials and plastics are especially used as the material for the remaining seat bucket frame and the seat bucket. Although such motor vehicle bucket seats which are formed from numerous structural elements have a good ratio of weight and dimensional stability, they are likewise complicated to produce, which is associated with high production costs and a great outlay on production time.

### SUMMARY OF THE INVENTION

The invention is based on an object of providing a motor vehicle bucket seat which can be produced cost-effectively and in a simple manner, has a low overall weight and is particularly dimensionally stable.

The motor vehicle bucket seat according to the invention comprises a metallic seat bucket frame which has a backrest region connected rigidly to a seat surface region. The seat bucket frame here is formed from at least two seat bucket frame side parts and a seat cushion bucket arranged in between in the seat surface region, wherein the seat bucket frame side parts are arranged overlapping in at least one connecting region.

The use of metal, in particular sheet metal, as material for the seat bucket frame advantageously permits particularly simple and cost-effective production. Furthermore, by suitable choice of the material thickness and suitable deformation of the material, a high strength can be achieved for the seat bucket frame, with the overall weight advantageously being able to be kept low at the same time. The overlapping of at least two seat bucket frame side parts of the seat bucket frame permits particularly simple deformation of the individual seat bucket frame side parts and therefore cost-effective production of the seat bucket frame overall. Furthermore, by production of the seat bucket frame from at least two individual seat bucket frame side parts, a significantly more complex shaping is possible, as a result of which greater dimensional stability and/or a low weight of the component can advantageously be achieved.

Furthermore, according to the invention, the seat bucket frame has two seat bucket frame side parts which are manufactured from in each case two structural elements, wherein the structural elements are fastened to each other in an overlapping manner in the transition region between seat surface region and backrest region. By production of the seat bucket frame from two seat bucket frame side parts, which are in each case formed from two structural elements, it is possible, in a simple manner and with no production costs, to produce a seat bucket frame of particularly complex shape, as a result of which very particularly high dimensional stability can be achieved. This in turn permits the use of particularly thin metal sheets for producing the structural elements of the seat bucket frame, and therefore the weight of the motor vehicle bucket seat is reduced in a particularly advantageous manner.

In addition, the overlapping arrangement of the two structural elements of a seat bucket frame side part in the overlapping region between seat surface region and backrest region ensures particularly high stability, since the material thickness is increased, preferably doubled, by the overlap. Increased stability in this region is particularly important since severe forces acting on a person on the motor vehicle bucket seat occur there, for example, in the event of a motor vehicle accident or in the event of sharp acceleration of the motor vehicle.

A motor vehicle bucket seat is basically understood as meaning any seat which can be used in a motor vehicle and has a seat bucket. Furthermore, the motor vehicle bucket seat can comprise any further components with any function. In particular, the motor vehicle bucket seat can have adjustment devices for adjusting the seat position and/or seat inclination, safety devices, such as airbags or belt elements, or support elements, such as side supports, head supports or lumbar supports.

The seat bucket is basically a component of the motor vehicle bucket seat that at least partially accommodates a person sitting in the motor vehicle bucket seat and stabilizes the person in a sitting position. For this purpose, the seat bucket has a backrest region which supports at least part of the person's back, but preferably also the head and/or the side upper body. The person sits on a further region, the seat surface region, and is supported at least against the gravity acting on the person; furthermore, the seat surface region preferably also provides lateral stabilization.

A further feature of the seat bucket is that the seat surface region is arranged rigidly with respect to the backrest region, that is to say, a relative movement between the two components is not possible.

The seat bucket comprises at least one seat bucket frame which has the function of ensuring the dimensional stability of the seat bucket, wherein the seat bucket frame is preferably arranged in an encircling manner on an outer border of the seat bucket.

A metallic seat bucket frame is understood here as meaning all seat bucket frames which are substantially formed of metallic components, in particular metal components thereof that ensure the stability.

A seat cushion bucket is basically understood as meaning any component which at least partially bears a person on the motor vehicle bucket seat and is arranged here in the region of the posterior and/or the legs, in particular the thighs of the person.

The seat cushion bucket can be connected here to a seat bucket frame encircling the motor vehicle bucket seat, or can itself form part of such a frame. Furthermore, the seat cushion bucket can be formed integrally or can consist of a plurality of structural elements. The seat cushion bucket is preferably formed from the same material as at least that part of the seat bucket frame which is adjacent to the seat cushion bucket.

In principle, the integrally bonded connection of the seat cushion bucket to the seat bucket frame side parts can take place in any manner, for example by adhesive bonding, welding or hot soldering; the seat cushion bucket is preferably welded to the seat bucket frame side parts by means of a laser welding method.

According to an advantageous refinement of the invention, the two structural elements of the seat bucket frame side parts are in each case connected to each other in an integrally bonded manner, wherein this connection is undertaken preferably by means of a laser welding method. An integrally bonded connection advantageously ensures here a particularly stable connection of the two structural elements, wherein the integrally bonded connection basically takes place in any manner, for example by welding, hot soldering or adhesive bonding. However, the integrally bonded connection particularly preferably takes place by means of a laser welding method, as a result of which the components can be connected particularly precisely, rapidly and very particularly preferably also fully automatically and therefore the production costs are kept as low as possible.

According to a further refinement of the invention, the seat bucket frame is formed from two seat bucket frame side parts and a seat cushion bucket which is arranged in between in the seat surface region and is connected to the seat bucket frame side parts in an integrally bonded manner.

According to an advantageous development of the invention, at least one crossmember is arranged on the seat bucket frame between the two seat bucket frame side parts, preferably in the transition region between seat surface region and backrest region, which crossmember is connected to the seat bucket frame particularly preferably in an integrally bonded manner. The crossmember here can basically have any shape and can be formed from any material as long as it is connected to the two seat bucket frame side parts and therefore increases the stability of the motor vehicle bucket seat in a simple manner.

The crossmember can basically be formed from an individual component or from a plurality of components, and/or, in addition to the increase in stability, can carry out further functions, for example the accommodating and/or fastening of further components, such as a lumbar support or seat support.

The crossmember is preferably formed substantially from metal, particularly preferably from the same metal as the seat bucket frame side parts. The crossmember also preferably involves an integral component and, particularly preferably, a sheet metal component deformed a number of times.

According to an advantageous refinement of the invention, a support structure is arranged on the seat bucket frame, preferably between the two seat bucket frame side parts of the seat bucket frame, which support structure is connected to the seat bucket frame particularly preferably in an integrally bonded manner. The primary task of the support structure is to further stabilize the motor vehicle bucket seat, wherein the support structure is preferably formed from metallic components and particularly preferably from metal strips or metal wires. Furthermore, the support structure can also serve to damp a superimposition of forces acting on the motor vehicle bucket seat on a person on said seat.

According to a further refinement of the invention, an outer edge of the seat bucket frame is at least partially, preferably completely, formed as a beading, as a result of which the dimensional stability of the outer edge is increased in a simple manner. The beading is understood here as meaning any, preferably at least right-angled folding over of the border region, wherein the beading can also be formed from a plurality of tightly consecutive folds of the material.

According to an advantageous development of the invention, the support structure comprises at least one second crossmember and/or an underspringing element (suspension element), wherein, particularly preferably, the second crossmember and/or the seat underspringing element are connected to the seat bucket frame in an integrally bonded manner.

The underspringing element here is understood as meaning any structural element which damps the forces acting on a person on the motor vehicle bucket seat, and/or can distribute said forces by means of deformation. The underspringing element here is preferably formed from metal, particularly preferably from metal wire. Very particularly preferably, the underspringing element here has sections running both parallel and at right angles to the seat bucket frame side parts.

In principle, the second crossmember here can have any shape and can be composed of any material. Furthermore, the second crossmember can be formed from an individual component or else from a plurality of components. The second crossmember is preferably composed of metal, particularly preferably of sheet metal which is very particularly preferably shaped in the form of a profile.

According to a preferred refinement of the invention, the underspringing element comprises at least one seat underspringing element in the seat surface region and at least one backrest underspringing element (suspension element) in the backrest region, said underspringing elements preferably being formed in each case from a plurality of wires, wherein, particularly preferably, the wires of an underspringing element are connected to one another to form a lattice structure, as a result of which uniform support is achieved in the region of the backrest and/or the seat surface. The use of metal wires here simultaneously permits good spring characteristics and high stability at a comparatively low overall weight.

According to an advantageous development of the invention, a head support element is arranged on the seat bucket frame, wherein the head support element is preferably designed as an integral component, in particular as a head support sheet, and is connected to the seat bucket frame particularly preferably in an integrally bonded manner. Furthermore, the head support element preferably has recesses in order to keep the overall weight as low as possible. The head support element basically has the task of stabilizing and of reinforcing the seat bucket frame in a region on which the head of a person on the motor vehicle bucket seat is located. For this purpose, the head support element can basically have any shape. Furthermore, it preferably has a surface for receiving a head support cushion.

According to a further advantageous refinement of the invention, the seat bucket frame and/or the support structure is formed from sheet metal, preferably from steel sheet, and has a material thickness of between 0.4 and 1 mm, preferably between 0.5 and 0.8 mm, as a result of which, firstly, high dimensional stability of the components is ensured and, secondly, the overall weight of the motor vehicle seat frame is kept as low as possible.

In order to produce a motor vehicle bucket seat, two seat bucket frame side parts are connected to each other in an integrally bonded manner to form a seat bucket frame, wherein each of the seat bucket frame side parts is formed from two structural elements which are arranged on each other in an overlapping manner and are connected to each other in an integrally bonded manner by means of a laser welding method. The sequence of connecting the individual components to one another in an integrally bonded manner is basically as desired, but preferably first of all the two structural elements which form each of the seat bucket frame side parts are in each case arranged in an overlapping manner and are welded to each other by means of the laser welding method. Subsequently, the two seat bucket frame side parts are then preferably likewise connected to each other in an integrally bonded manner, particularly preferably likewise by means of the laser welding method. Very particularly preferably, the laser welding method is carried out fully automatically here.

The method makes it possible to produce metal motor vehicle bucket seats of particularly complex shape in a simple manner and particularly cost-effectively. Furthermore, because of the complex shape, thin sheet metal can be used as the starting material, as a result of which a particularly low overall weight of the motor vehicle bucket seat can be achieved.

According to advantageous development of the method, in the front seat region of the motor vehicle bucket seat, a seat cushion bucket is connected to the two seat bucket frame side parts and/or at least one crossmember is connected to the seat bucket frame, preferably in the region of the overlapping of the structural elements of the seat bucket frame side parts, wherein the attaching preferably takes place by means of an integrally bonded method, particularly preferably by means of a laser welding method, which advantageously simplifies the production process even further and increases the dimensional stability of the motor vehicle bucket seat even further.

An exemplary embodiment of the invention is explained in more detail below with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective illustration showing an embodiment of a motor vehicle bucket seat; and

FIG. 2 is a perspective exploded illustration of the embodiment of the motor vehicle bucket seat that is depicted in FIG. 1.

### DESCRIPTION OF THE PREFERRED EMBODIMENTS

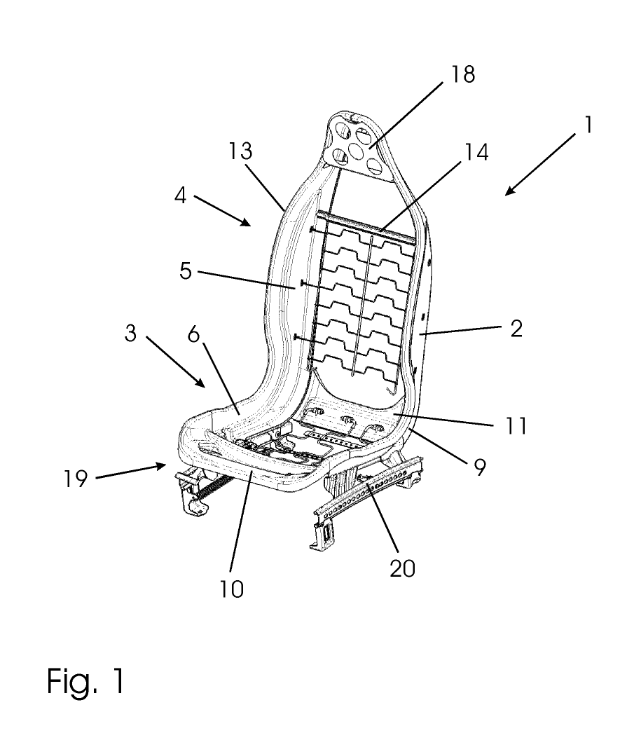

An embodiment of motor vehicle bucket seat 1 that is illustrated in FIG. 1 has a seat bucket frame 2 which is formed from sheet metal of a thickness of 0.8 mm. The seat bucket frame 2 here comprises a seat surface region 3 and a backrest region 4 arranged approximately at a right angle thereto.

The seat bucket frame 2 here is formed from two seat bucket frame side parts 7, 8 which are arranged in an overlapping manner at the upper end of the motor vehicle bucket seat 1, which end faces the head of a person on the motor vehicle bucket seat 1, and are connected to each other in an integrally bonded manner by means of a laser welding method.

Each of the two seat bucket frame side parts 7, 8 is formed from two structural elements 5, 6 which are arranged overlapping in the entire transition region 9 between the seat surface region 3 and the backrest region 4 and are likewise connected to each other in an integrally bonded manner by means of the laser welding method. As a result, in the transition region 9, which is bent and is subject to particular loading, the material thickness is doubled in comparison to the rest of the seat bucket frame 2 to 1.6 mm and particularly high dimensional stability is therefore achieved in a simple manner. The two seat bucket frame side parts 7, 8 are formed here in a mirror-symmetrical manner with respect to the center of the motor vehicle bucket seat 1 and are formed from a sheet metal profile which is deformed a number of times.

In the front seat region 19, the seat bucket frame 2 is not formed by the two seat bucket frame side parts 7, 8, but rather by a seat cushion bucket 10 which is connected to the seat bucket frame side parts 7, 8 in a likewise overlapping and integrally bonded manner by means of the laser welding method. The seat cushion bucket 10 here is formed from sheet metal deformed a number of times and has a material thickness of 0.6 mm.

The encircling outer edge 13 of the seat bucket frame 2 here is designed as a beading, as a result of which not only is the dimensional stability of the seat bucket frame 2 increased in a simple manner, but also injury to a person on the motor vehicle bucket seat 1 by sharp outer edges 13 of the sheet metal forming the seat bucket frame 2 is prevented.

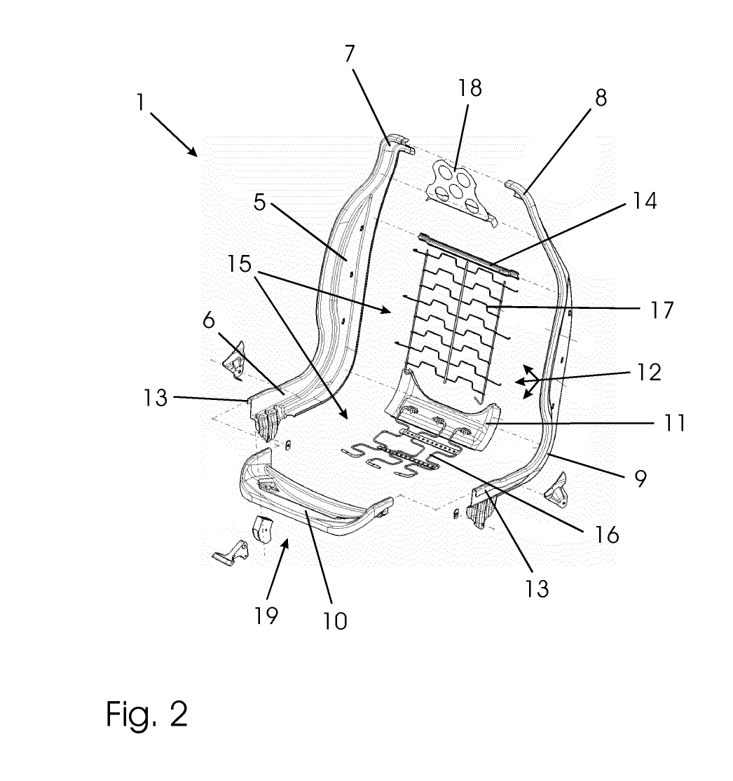

A support structure 12 formed from numerous components is arranged in the interior region of the seat bucket frame 2 (see FIG. 2), wherein some of the components serve primarily to increase the dimensional stability of the motor vehicle bucket seat 1 while the function of other of the components resides especially in improving the use comfort.

Of high importance for the dimensional stability of the motor vehicle bucket seat 1 is a first crossmember 11, which is arranged in the transition region 9 between seat surface region 3 and backrest region 4 on both sides between the two seat bucket frame side parts 7, 8. The crossmember 11 here has a surface curvature following the shape of the transition region 9 and is formed as a profiled component from sheet metal of a thickness of 0.6 mm. The connection to the two seat bucket frame side parts 7, 8 takes place in each case by an integrally bonded connection by means of the laser welding method, with the crossmember 11 being fastened in the process so as to rest on a surface of the respective seat bucket frame side part 7, 8.

Furthermore, in order to further improve the dimensional stability in the backrest region 4, a second crossmember 14 composed of sheet metal which is of thickness of 0.5 mm and is deformed to form a profile is arranged between the two seat bucket frame side parts 7, 8 and is connected thereto in an overlapping and integrally bonded manner.

Underspringing elements 15 which are substantially formed from bent wires and metal profiles are arranged in each case both in the backrest region 4 between the first and the second crossmember 11, 14 and in the seat surface region 3 between the seat cushion bucket 10 and the first crossmember 11. The underspringing elements 15 here have the function of damping forces occurring in the respective regions between the motor vehicle bucket seat 1 and a person thereon.

The individual components of a seat underspringing element 16 in the seat surface region 3 are arranged here in each case on the first crossmember 11 and on the seat cushion bucket 10 and therefore run substantially parallel to the two seat bucket frame side parts 7, 8 in this region.

A backrest underspringing element 17, which is arranged in the backrest region 4 between the first and the second crossmember 11, 14, consists of a plurality of components which are fastened to the two seat bucket frame side parts 7, 8 and run substantially orthogonally with respect thereto.

Finally, at the upper end of the backrest region 4, a head support element 18 consisting of sheet metal of a thickness of 0.5 mm is connected to the two seat bucket frame side parts 7, 8 in an integrally bonded manner by means of the laser welding method. The head support element 18 has five recesses here in order to reduce the overall weight.

The entire motor vehicle bucket seat 1 is connected to a pair of seat rails 20 by means of fastening means arranged in the seat surface region 3 on the lower side of the seat bucket frame 2, and is fastened to a motor vehicle structure via said pair of seat rails 20.

While specific embodiments of the invention have been shown and described in detail to illustrate the application of the principles of the invention, it will be understood that the invention may be embodied otherwise without departing from such principles.

1. A motor vehicle bucket seat comprising a metallic seat bucket frame comprising a backrest region connected rigidly to a seat surface region, wherein the seat bucket frame comprises:
at least two seat bucket frame side parts arranged overlapping in at least one connecting region; and
a seat cushion bucket arranged in between the at least two seat bucket frame side parts, in the seat surface region, wherein the seat bucket frame side parts are manufactured from in each case, at least two structural elements which are fastened to each other in an overlapping manner in a transition region between the seat surface region and the backrest region.

2. The motor vehicle bucket seat as claimed in claim 1, wherein the two structural elements of the seat bucket frame side parts are, in each case, connected to each other with an integrally bonded connection, wherein said connection is produced by means of a laser welding method.

3. The motor vehicle bucket seat as claimed in claim 1, wherein the seat cushion bucket is connected to the seat bucket frame side parts with an integrally bonded connection.

4. The motor vehicle bucket seat as claimed in claim 1, further comprising at least one crossmember arranged on the seat bucket frame between the two seat bucket frame side parts, in the transition region the between seat surface region and the backrest region, which crossmember is connected to the seat bucket frame with an integrally bonded connection.

5. The motor vehicle bucket seat as claimed in claim 1, further comprising a support structure arranged on the seat bucket frame between the two seat bucket frame side parts of the seat bucket frame, which support structure is connected to the seat bucket frame with an integrally bonded connection.

6. The motor vehicle bucket seat as claimed in claim 1, wherein an outer edge of the seat bucket frame is at least partially formed as a beading.

7. The motor vehicle bucket seat as claimed in claim 5, further comprising at least one crossmember arranged on the seat bucket frame between the two seat bucket frame side parts, in the transition region the between seat surface region and the backrest region, wherein the support structure comprises at least one second crossmember and/or an underspringing element, wherein, the second crossmember and/or the seat underspringing element are connected to the seat bucket frame in an integrally bonded manner.

8. The motor vehicle bucket seat as claimed in claim 7, wherein the underspringing element comprises at least one seat underspringing element in the seat surface region and at least one backrest underspringing element in the backrest region, said underspringing elements being formed in each case from a plurality of wires, wherein the wires of an underspringing element are connected to one another.

9. The motor vehicle bucket seat as claimed in claim 1, further comprising a head support element is arranged on the seat bucket frame, wherein the head support element is designed as an integral head support sheet, and is connected to the seat bucket frame with an integrally bonded connection.

10. The motor vehicle bucket seat as claimed in claim 1, wherein the seat bucket frame and/or the support structure is formed from steel sheet, and has a material thickness of between 0.4 and 1 mm.
